(19) United States
(12) Patent Application Publication
(10) Pub. No.: US 2025/0309948 A1
(43) Pub. Date: Oct. 2, 2025

(54) COMMUNICATIONS NETWORK AND METHODS WITH WIRELESS COMMUNICATION

(71) Applicant: Sharp Kabushiki Kaisha, Sakai City (JP)

(72) Inventors: Hitesh Poddar, New York City, NY (US); Tomoki Yoshimura, Camas, WA (US); Zhanping Yin, Vancouver, WA (US)

(21) Appl. No.: 18/622,844

(22) Filed: Mar. 29, 2024

(51) Int. Cl. H04B 7/0456

(52) U.S. Cl. CPC H04B 7/0456

(57) ABSTRACT

A user equipment (UE) is described. The UE includes transmitting circuitry configured to configure a far-field codebook comprising a plurality of far-field candidate precoders. The transmitting circuitry is further configured to configure a near-field codebook comprising a plurality of near-field candidate precoders. The transmitting circuitry is yet further configured to select a codebook and transmit using the selected codebook.

### TECHNICAL FIELD

The present disclosure relates generally to communication systems. More specifically, the present disclosure relates communications networks and methods with wireless communication.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more gNBs and one or more UEs in which systems and methods described herein may be implemented;

FIG. 2A is a diagram illustrating an example of planer wave in far-field;

FIG. 2B is a diagram illustrating an example of spherical wave in near-field;

FIG. 3A is a diagram illustrating an example of phase difference between adjacent transmit antennas;

FIG. 3B is a diagram illustrating another example of phase difference between adjacent transmit antennas;

FIG. 4 is a diagram illustrating another example of the phase shift concept in the near-field assumption;

FIG. 5 is a block diagram illustrating one implementation of a gNB;

FIG. 6 is a block diagram illustrating one implementation of a UE;

FIG. 7 illustrates various components that may be utilized in a UE;

FIG. 8 illustrates various components that may be utilized in a gNB;

FIG. 9 is a block diagram illustrating one implementation of a UE in which the systems and methods described herein may be implemented;

FIG. 10 is a block diagram illustrating one implementation of a gNB in which the systems and methods described herein may be implemented;

FIG. 11 is a flow diagram illustrating an example of a method by a UE; and

FIG. 12 is a flow diagram illustrating another example of a method by a UE.

### DETAILED DESCRIPTION

A user equipment (UE) is described. The UE includes transmitting circuitry configured to configure a far-field codebook comprising a plurality of far-field candidate precoders. The transmitting circuitry is further configured to configure a near-field codebook comprising a plurality of near-field candidate precoders. The transmitting circuitry is yet further configured to select a codebook and transmit using the selected codebook.

Selecting the codebook to use may comprise selecting a precoder to use. The precoder may be selected from the plurality of far-field candidate precoders and the plurality of near-field candidate precoders.

The UE may also include receiving circuitry configured to receive a distance threshold from a base station (gNB) via radio resource control (RRC) signaling. In some implementations, the distance threshold is a Rayleigh distance. If no distance threshold is received from the gNB, the UE may use the distance threshold as Rayleigh distance.

The receiving circuitry may be configured to receive a largest dimension of an antenna from the gNB via RRC signaling. In some examples, the Rayleigh distance is computed using the largest dimension of the antenna and the wavelength from the gNB.

In some examples, the transmitting circuitry may be configured to transmit a request to the gNB for the largest dimension of the antenna.

Selecting the codebook and the precoder to use within that codebook use may include comparing a distance (r) between the UE and the gNB with the distance threshold. When r is greater than the distance threshold, a far-field precoder may be selected. When r is less than the distance threshold, a near-field precoder may be selected.

In further examples, selecting the precoder to use may include selecting a far-field precoder when r is greater than the distance threshold, selecting a near-field precoder when r is less than the distance threshold and greater than a second distance threshold.

A base station (gNB) is also described. The gNB includes receiving circuitry configured to configure a far-field codebook comprising a plurality of far-field candidate precoders. The receiving circuitry is further configured to configure a near-field codebook comprising a plurality of near-field candidate precoders. The receiving circuitry is yet further configured to receive a codebook selection from the UE. The codebook is selected from the far-field codebook and the near-field codebook. The receiving circuitry is also configured to receive transmissions from the UE using the selected codebook.

The gNB may also include transmitting circuitry configured to transmit the distance threshold to the UE via RRC signaling. The transmitting circuitry may also be configured to transmit a largest dimension of an antenna and a wavelength to the UE via RRC signaling.

A method by a UE is also described. The method includes configuring a far-field codebook comprising a plurality of far-field candidate precoders. The method includes configuring a near-field codebook comprising a plurality of near-field candidate precoders. The method also includes selecting a codebook to use and transmitting using the selected codebook.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a wireless terminal, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a wireless terminal. However, as the scope of the present disclosure should not be limited to the 3GPP standards, the terms “wireless terminal” and “wireless communication device” may be used interchangeably herein to mean the more general term “wireless communication device.” A wireless terminal may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an gNB and a wireless terminal. It should also be noted that in E-UTRA and E-UTRAN overall description, as used herein, a “cell” may be defined as “combination of downlink and optionally uplink resources.” The linking between the carrier frequency of the downlink (DL) resources and the carrier frequency of the uplink resources may be indicated in the system information transmitted on the downlink resources.

“Configured cells” are those cells of which the wireless terminal is aware and is allowed by an gNB to transmit or receive information. “Configured cell(s)” may be serving cell(s). The wireless terminal may receive system information and perform the required measurements on all configured cells. “Configured cell(s)” for a radio connection may include a primary cell and/or no, one, or more secondary cell(s). “Activated cells” are those configured cells on which the wireless terminal is transmitting and receiving. That is, activated cells are those cells for which the wireless terminal monitors the physical downlink control channel (PDCCH) and in the case of a downlink transmission, those cells for which the wireless terminal decodes a physical downlink shared channel (PDSCH). “Deactivated cells” are those configured cells that the wireless terminal is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IoT)) but lower than URLLC and eMBB.

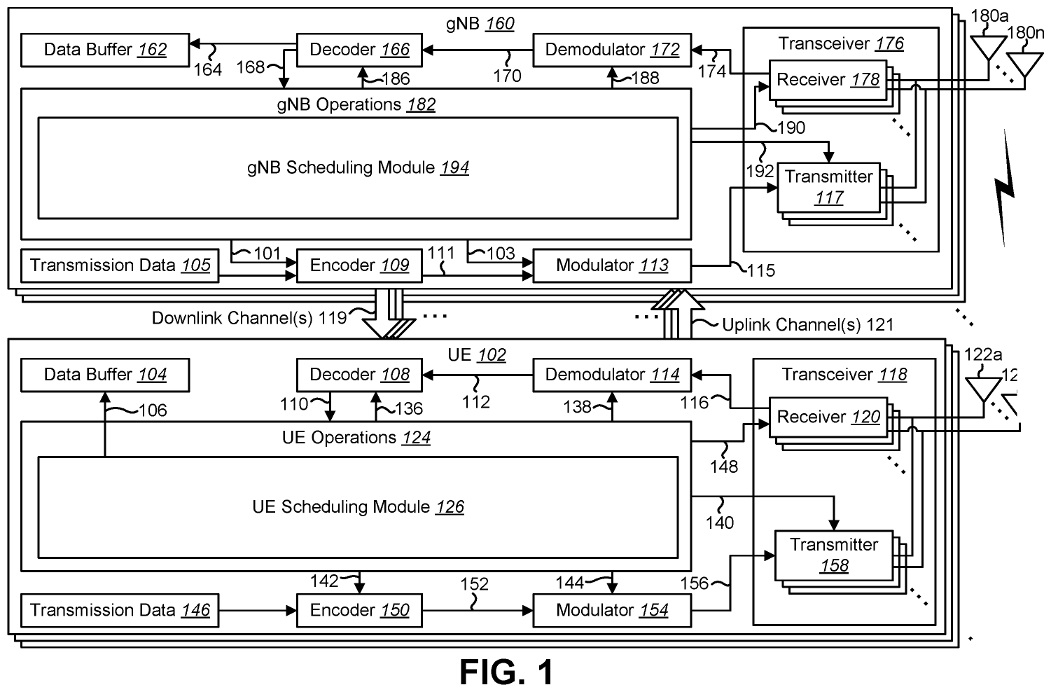

FIG. 1 is a block diagram illustrating one implementation of one or more gNBs 160 and one or more UEs 102 in which systems and methods described herein may be implemented. The one or more UEs 102 communicate with one or more gNBs 160 using one or more antennas 122a-n. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH (Physical Uplink Control Channel) and a PUSCH (Physical Uplink Shared Channel), PRACH (Physical Random Access Channel), etc. For example, uplink channels 121 (e.g., PUSCH) may be used for transmitting UL data (i.e., Transport Block(s), MAC PDU, and/or UL-SCH (Uplink-Shared Channel)).

In some examples, UL data may include URLLC data. The URLLC data may be UL-SCH data. Here, URLLC-PUSCH (i.e., a different Physical Uplink Shared Channel from PUSCH) may be defined for transmitting the URLLC data. For the sake of simple description, the term “PUSCH” may mean any of (1) only PUSCH (e.g., regular PUSCH, non-URLLC-PUSCH, etc.), (2) PUSCH or URLLC-PUSCH, (3) PUSCH and URLLC-PUSCH, or (4) only URLLC-PUSCH (e.g., not regular PUSCH).

Also, for example, uplink channels 121 may be used for transmitting Hybrid Automatic Repeat Request-ACK (HARQ-ACK), Channel State Information (CSI), and/or Scheduling Request (SR) signals. The HARQ-ACK may include information indicating a positive acknowledgment (ACK) or a negative acknowledgment (NACK) for DL data (i.e., Transport Block(s), Medium Access Control Protocol Data Unit (MAC PDU), and/or DL-SCH (Downlink-Shared Channel)).

The CSI may include information indicating a channel quality of downlink. The SR may be used for requesting UL-SCH (Uplink-Shared Channel) resources for new transmission and/or retransmission. For example, the SR may be used for requesting UL resources for transmitting UL data.

The one or more gNBs 160 may also transmit information or data to the one or more UEs 102 using one or more downlink channels 119, for instance. Examples of downlink channels 119 include a PDCCH, a PDSCH, etc. Other kinds of channels may be used. The PDCCH may be used for transmitting Downlink Control Information (DCI).

Each of the one or more UEs 102 may include one or more transceivers 118, one or more demodulators 114, one or more decoders 108, one or more encoders 150, one or more modulators 154, a data buffer 104, and a UE operations module 124. For example, one or more reception and/or transmission paths may be implemented in the UE 102. For convenience, only a single transceiver 118, decoder 108, demodulator 114, encoder 150, and modulator 154 are illustrated in the UE 102, though multiple parallel elements (e.g., transceivers 118, decoders 108, demodulators 114, encoders 150, and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include a UE scheduling module 126. In some examples, the UE scheduling module 126 may be utilized to perform joint coding and/or multiplexing of deferred SPS HARQ-ACK as described herein. For instance, the UE 102, the UE operations module 124, and/or the UE scheduling module 126 may perform one or more of the methods, operations, functions, approaches, and/or examples described herein.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162, and a gNB operations module 182. For example, one or more reception and/or transmission paths may be implemented in a gNB 160. For convenience, only a single transceiver 176, decoder 166, demodulator 172, encoder 109, and modulator 113 are illustrated in the gNB 160, though multiple parallel elements (e.g., transceivers 176, decoders 166, demodulators 172, encoders 109, and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first gNB-decoded signal 164 may comprise received payload data, which may be stored in a data buffer 162. A second gNB-decoded signal 168 may comprise overhead data and/or control data. For example, the second gNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include a gNB scheduling module 194. The gNB scheduling module 194 may perform operations as described herein. In some examples, the gNB scheduling module 194 may be utilized to perform joint coding and/or multiplexing of deferred SPS HARQ-ACK as described herein. For instance, the gNB 160, the gNB operations module 182, and/or the gNB scheduling module 194 may perform one or more of the methods, operations, functions, approaches, and/or examples described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the gNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

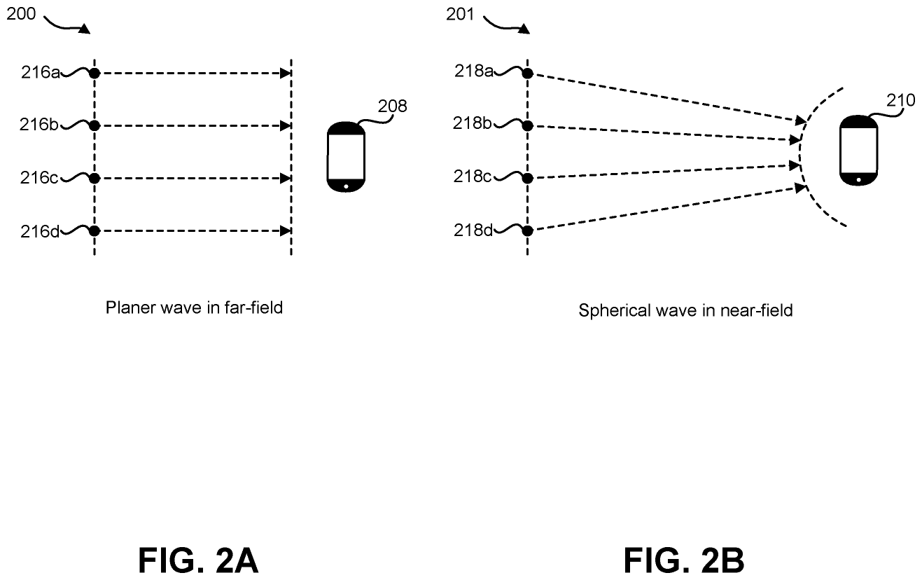

In 3GPP, physical layer techniques have been evaluated based on a channel model, which specifies a stochastic channel model implementing small-scale fading, with far-field assumptions. In the far-field assumption, the transmitter and the receiver being far, the signal from the transmitter is observed as a planer wave from the receiver, as shown in FIG. 2A.

A near-field assumption will be introduced in the channel model. In the near field assumption, the signal from the transmitter is observed as a spherical wave, as shown in FIG. 2B.

The key difference between them is in the phase shift at each transmitter antenna (216a-d, 218a-d). However, up to now, there has been no study or development for MIMO precoding with the near-field assumption.

FIG. 2A is a diagram 200 of an example of a planer wave in the far-field assumption. The signal is transmitted from a base station antenna that comprises a first transmit antenna element 216a, a second transmit antenna element 216b, a third transmit antenna element 216c, and a fourth transmit antenna element 216d. The signal is received by the UE 208.

FIG. 2B is a diagram 201 of an example of spherical wave in the near-field assumption. The signal is transmitted from a base station antenna that comprises a first transmit antenna element 218a, a second transmit antenna element 218b, a third transmit antenna element 218c, and a fourth transmit antenna element 218d. The signal is received by the UE 210.

The systems and methods herein will specify a codebook for UEs in near-field, in addition to the existing codebook for UEs 208 in far-field, and will provide a method to select a codebook in the near field and far field.

The near-field precoder has one or more of the following characteristics:
Each of the precoders is calculated based on the relative distance “r” between the base station (eNB, gNB or BS) and UE.
Each of the precoders are calculated based on the square of the transmitter (Tx) antenna (216a-d, 218a-d) spacing “d\hat{ }2”.

In some implementations, the relative distance “r” between the BS and UE (208, 210) and the square of the Tx antenna (216a-d, 218a-d) spacing “d\hat{ }2” may be signaled from the BS to the UE (208, 210).

The near field codebooks and far field codebooks maybe selected by the UE/BS based on BS/UE's relative position estimation compared to a threshold distance which separates the near field and far field.

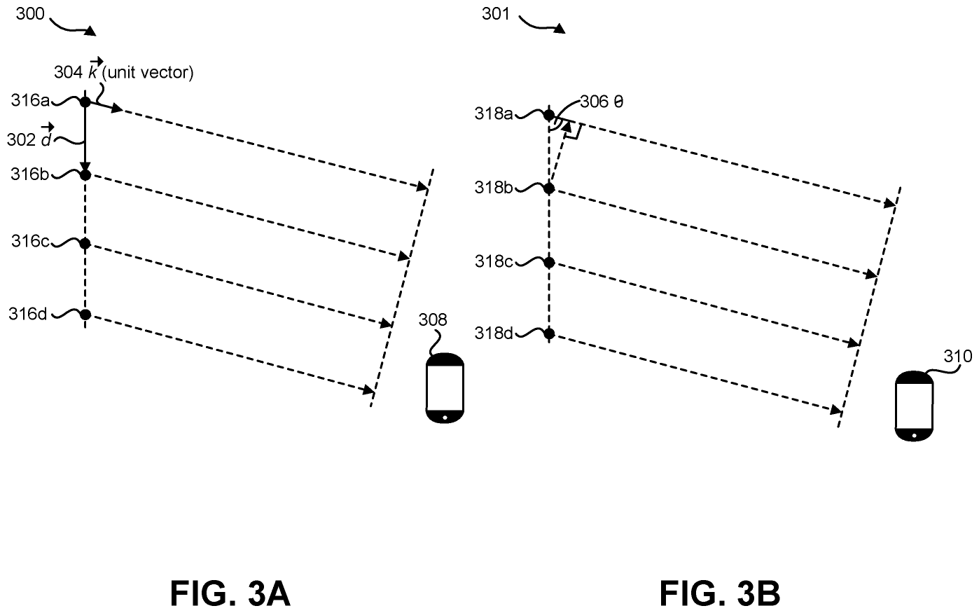

Basic assumptions of near-field and far-field have been made. The channel model assumes planer waves. FIGS. 3A and 3B are diagrams (300, 301) showing examples of phase difference between the adjacent Tx antennas (316a-d, 318a-d).

FIG. 3A shows the definition of vectors 304 \vec{k} and 302 \vec{d}. Here, 304 \vec{k} is a unit vector representing the wave propagation, and 302 \vec{d} is a vector representing the Tx antenna element. 302 \vec{d} starts at the first Tx antenna element 316a to the second antenna element 316b. Thus, the norm of 302 \vec{d} is the Tx antenna space. FIG. 3A also illustrates a third antenna element 316c and a fourth antenna element 316d. The signals are transmitted to the UE 308.

FIG. 3B shows the phase shift concept. In the far-field, 304 \vec{k} represents the wave propagation for all the Tx antenna elements 318a-d. In other words, the angle 306 Ø of the wave propagation is the same in all the Tx antenna elements 318a-d. Therefore, the difference in propagation distance in the adjacent Tx antenna elements 318a-d can be represented as the solid line shown in FIG. 3B, which is one side of the triangle formed by the vector 302 \vec{d}, and the normal vector from the second antenna element 318b to the propagation vector 304 \vec{k} (shown in FIG. 3A). The signals are transmitted to the UE 310.

With the above, the difference in propagation distance in the adjacent Tx antenna elements is −\vec{k}·\vec{d}, which is the inner product of the vectors \vec{k} and \vec{d}. The phase difference in the adjacent Tx antenna elements is

$$exp ( \frac{j 2 π ( - \vec{k} \cdot \vec{d} )}{{λ}_{0}} ) .$$

In the far-field assumption, the phase difference in the adjacent Tx antenna elements is

$$exp ( \frac{j 2 π ( - \vec{k} \cdot \vec{d} )}{{λ}_{0}} ) .$$

Furthermore, as an example, assume that the norm of the elements is vector 302 \vec{d} is λ₀/2, the phase difference can be exp (−jπ cos θ).

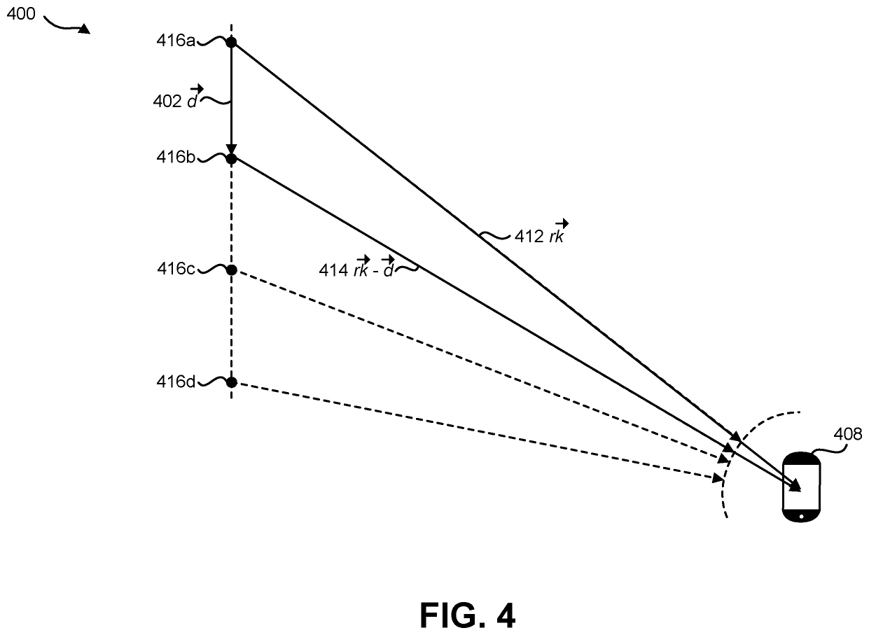

In the near-field assumption, the angles of the propagation vectors of the respective antenna elements are different. Therefore, the phase difference in two antenna elements is calculated differently. FIG. 4 is a diagram 400 of an example of the phase shift concept in the near-field assumption. In FIG. 4, \vec{k} represents the wave propagation for the first Tx antenna element 416a, and r represents the length from the first antenna element 416a to the receiver 408. Thus, the vector from the 2^{nd} antenna element 416b to the receiver 408 is r\vec{k}-\vec{d} (414). And thus, the phase difference in the first and second antenna elements (416a, 416b) is

$$exp ( \frac{j 2 π ( r - ‖ r \vec{k} - \vec{d} ‖ )}{{λ}_{0}} ) .$$

The phase difference term

$$exp ( \frac{j 2 π ( r - ‖ r \vec{k} - \vec{d} ‖ )}{{λ}_{0}} )$$

can be decomposed by Fresnel assumption. In the assumption, Talyor expansion is applied as in

$$‖ r \vec{k} - \vec{d} ‖ = \sqrt{{r}^{2} + ‖ \vec{d} ‖ - 2 r ( \vec{k} \cdot \vec{d} )} = r \cdot ( 1 + \frac{1}{2} \frac{{‖ \vec{d} ‖}^{2} - 2 r ( \vec{k} \cdot \vec{d} )}{{r}^{2}} + \frac{1}{8} \frac{{‖ \vec{d} ‖}^{4} - 4 r ( \vec{k} \cdot \vec{d} ) + 4 {{r}^{2} ( \vec{k} \cdot \vec{d} )}^{2}}{{r}^{4}} + ⋯ ) .$$

By omitting the higher order terms,

$$r - ‖ r \vec{k} - \vec{d} ‖ \approx r - r \cdot ( 1 + \frac{1}{2} \frac{{‖ \vec{d} ‖}^{2} - 2 r ( \vec{k} \cdot \vec{d} )}{{r}^{2}} + \frac{1}{8} \frac{4 {{r}^{2} ( \vec{k} \cdot \vec{d} )}^{2}}{{r}^{4}} ) = - ( \vec{k} \cdot \vec{d} ) + \frac{{‖ \vec{d} ‖}^{2}}{2 r} + \frac{{( \vec{k} \cdot \vec{d} )}^{2}}{2 r} .$$

Thus, in the Fresnel assumption, the phase difference term can be represented as

$$exp ( \frac{j 2 π ( - \vec{k} \cdot \vec{d} )}{{λ}_{0}} ) \cdot exp ( \frac{{‖ \vec{d} ‖}^{2} + {( \vec{k} \cdot \vec{d} )}^{2}}{2 r {λ}_{0}} ) .$$

Here, the first exponential term represents the phase for the far field and the second exponential term represents the phase for the near field.

Type-1 single panel codebook assumes the far-field. However, for determining the precoder in far-field, the parameters \vec{k}, 402 \vec{d}, and λ₀ are not used explicitly. Rather the parameters, O₁ and N₁ are used. For example, to derive the horizontal domain precoder, assuming that N₁ antenna elements are placed in the horizontal domain, the precoder is represented as

$${v}_{l} = {[ 1 , exp ( \frac{j 2 π l}{{O}_{1} {N}_{1}} ) , … , exp ( \frac{j 2 π l ( {N}_{1} - 1 )}{{O}_{1} {N}_{1}} ) ]}^{T} .$$

Here, l is the precoder index, and takes a value in the range between 0 and O₁N₁−1.

In CSI reporting, the base station provides configuration regarding O₁ and N₁. On receiving these configurations, the UE 408 can determine O₁N₁ precoders for vₗ.

Next, the UE 408 receives a channel state information reference signal (CSI-RS) from the base station. The UE 408 determines the best precoder which maximizes the signal-to-interference-plus-noise ratio (SINR) among the O₁N₁ precoders. The UE 408 reports the index 1 of the best precoder.

Similarly, the near-field precoder v′_{l,r} may be defined based on

$$exp ( \frac{{‖ \vec{d} ‖}^{2} + {( \vec{k} \cdot \vec{d} )}^{2}}{2 r {λ}_{0}} ) .$$

To determine this term, determine one or a part or all ∥\vec{d}∥², (\vec{k}·\vec{d}), r, and λ₀.

Where, ∥\vec{d}∥² may be obtained via:
Signaling from the BS using radio resource control (RRC) signaling.
Candidate values may be defined for |\vec{d}| or |\vec{d}|². For example, the candidate value set for ∥\vec{d}∥² may include one or more of

$$[ {( \frac{{λ}_{0}}{2} )}^{2} , {λ}_{0}^{2} , {( 2 {λ}_{0} )}^{2} , {( 4 {λ}_{0} )}^{2} ] .$$

The UE 408 may determine the best precoder among the codebook for respective candidate values and report the selected precoder.

For signaling from the BS using RRC signaling, the information may be signaled in a CSI reporting configuration as follows:
∥\vec{d}∥² may be indicated in the CSI reporting configuration.
One value from a set of candidate values for ∥\vec{d}∥² may be indicated in the CSI reporting configuration.
   |\vec{d}| may be indicated in the CSI reporting configuration. In this case |\vec{d}| has been signaled, and the UE 408 may compute ∥\vec{d}∥² from |\vec{d}|.
One value from a set of candidate values for |\vec{d}| may be indicated in the CSI reporting configuration.

(\vec{k}·\vec{d})² may be obtained via:
Signaling from the BS via RRC signaling.
Candidate values may be defined. The UE 408 may determine the best precoder among the codebook for respective candidate values and report the selected precoder, which implicitly reports the value of (\vec{k}·\vec{d})².

For signaling from the BS using RRC signaling, the information may be signaled in a CSI reporting configuration as follows:
(\vec{k}·\vec{d})² may be indicated in the CSI reporting configuration.
One value from a set of candidate values for (\vec{k}·\vec{d})² may be indicated in the CSI reporting configuration.
   |\vec{k}·\vec{d}| may be indicated in the CSI reporting configuration. In a case that |\vec{k}·\vec{d}| has been signaled, the UE 408 may compute (\vec{k}·\vec{d})² from |\vec{k}·\vec{d}|.
One value from a set of candidate values for |\vec{k}·\vec{d}| may be indicated in the CSI reporting configuration.

λ₀ may be determined using the frequency band information provided by the BS.

r is the relative distance between the UE 408 and BS and may be estimated by the UE 408 using the positioning reference signal from the BS or signaled via the BS.

The value of r estimated by the UE 408 may be:
Used directly for determining the precoder in the near field.
Rounded to the nearest integer in case the codebook is defined for only integer values of r.
May be mapped to a defined set of discrete integers of r using the minimum Euclidian distance in case the near field codebook is defined for certain discrete values of r. Using the discrete values of r ensures that the codebook is not defined for every r but specific values of r.

For signaling r from the BS using RRC signaling, the information may be signaled in a CSI reporting configuration as follows:
r may be indicated in the CSI reporting configuration.
One value from a set of candidate values for r may be indicated in the CSI reporting configuration.

When multiple codebooks are defined, i.e., codebooks for near field and far field, a robust selection mechanism may be required to choose the codebook based on whether the UE is in the near field or far field from the BS based. r_{threshold} may be defined at the distance which separates the near field and far field and can be provided by the BS to the UE or determined by the UE. For example, the value of r_{threshold} may be the Rayleigh distance or any other value provided by the BS to the UE. Thus, there are several ways to select codebooks as described below:
The UE estimates the relative distance r between the BS and the UE using the positioning reference signal from the BS and compares it with r_{threshold}. When r<r_{threshold}, the UE selects the codebook corresponding to the near field and when r>r_{threshold}, the UE selects the codebook corresponding to far field and the codebook index −l′, r is signalled by the UE in the CSI report for near-field. For the far field the existing technique may be used to signal l from the UE to BS in the CSI report.
The BS estimates the relative distance r between the BS and the UE using PRACH, sounding reference signal (SRS), or positioning reference signal and compares it with a threshold distance r_{threshold}. When r<r_{threshold}, the BS selects the codebook corresponding to the near field and when r>r_{threshold}, the BS selects the codebook corresponding to far field. Precoding matrix indicator (PMI) index (l′) within the codebooks defined for r is signalled by the BS to the UE in the CSI report for near field. For the far field the existing technique is used to signal l from the BS to UE in the CSI report.
The UE determines the best precoder which maximizes the SINR among the O₁N₁ precoders for vₗ and precoders for v′_{l,r}. The UE reports the codebook type and the precoder index in the CSI report. In this option the UE may evaluate the precoders in the two codebooks, i.e., the codebook based on the far-field and the codebook based on the near field. Then, the UE reports the best codebook among all the codebooks.

The distance threshold (r_{threshold}) may be sent from the BS to UE via RRC signaling. The value of the distance threshold (r_{threshold}) may be the Rayleigh distance or another other value which the BS finds appropriate to distinguish the near-field and far-field.

If the distance threshold (r_{threshold}) is not sent by the BS to UE, then the UE may assume that the distance threshold (r_{threshold}) is the Rayleigh distance. In order for the UE to compute the Rayleigh distance, the BS may provide the UE with the largest dimension of the antenna and the wavelength via RRC signaling. If the largest dimension of the antenna and the wavelength are not provided by the BS to the UE earlier, the UE may explicitly request for these parameters from the BS.

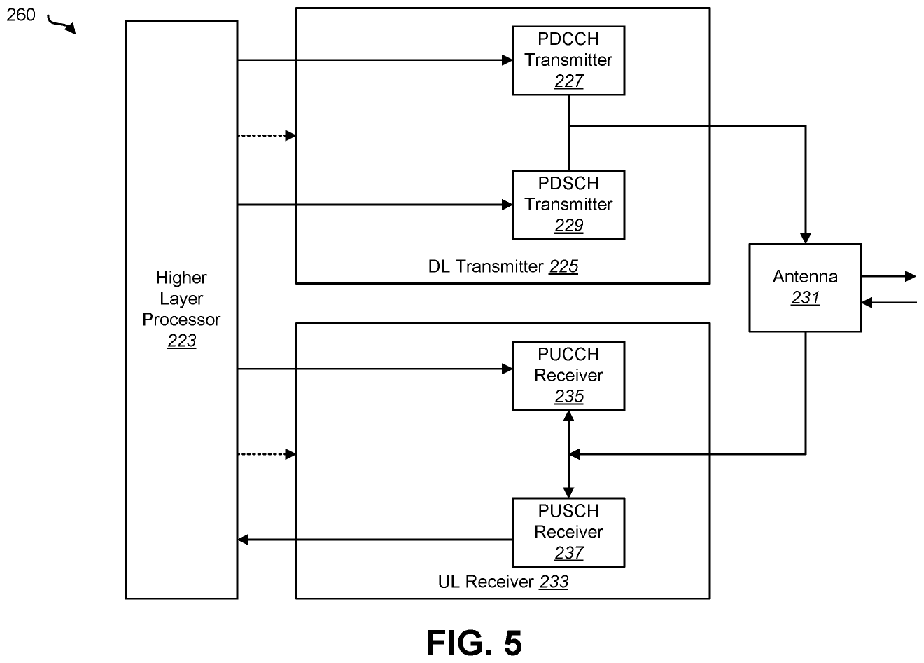

FIG. 5 is a block diagram illustrating one implementation of a base station, BS, eNB, or gNB 260. (Herein the terms base station, BS, eNB, and gNB are used interchangeably to refer to the base station.) The gNB 260 may be implemented in accordance with the gNB 160 described in connection with FIG. 1 in some examples, and/or may perform one or more of the functions described herein. The gNB 260 may include a higher layer processor 223, a DL transmitter 225, a UL receiver 233, and one or more antenna 231. The DL transmitter 225 may include a PDCCH transmitter 227 and a PDSCH transmitter 229. The UL receiver 233 may include a PUCCH receiver 235 and a PUSCH receiver 237.

The higher layer processor 223 may manage physical layer's behaviors (the DL transmitter's and the UL receiver's behaviors) and provide higher layer parameters to the physical layer. The higher layer processor 223 may obtain transport blocks from the physical layer. The higher layer processor 223 may send/acquire higher layer messages such as an RRC message and MAC message to/from a UE's higher layer. The higher layer processor 223 may provide the PDSCH transmitter transport blocks and provide the PDCCH transmitter transmission parameters related to the transport blocks.

The DL transmitter 225 may multiplex downlink physical channels and downlink physical signals (including reservation signal) and transmit them via transmission antennas 231. The UL receiver 233 may receive multiplexed uplink physical channels and uplink physical signals via receiving antennas 231 and de-multiplex them. The PUCCH receiver 235 may provide the higher layer processor 223 UCI. The PUSCH receiver 237 may provide the higher layer processor 223 received transport blocks.

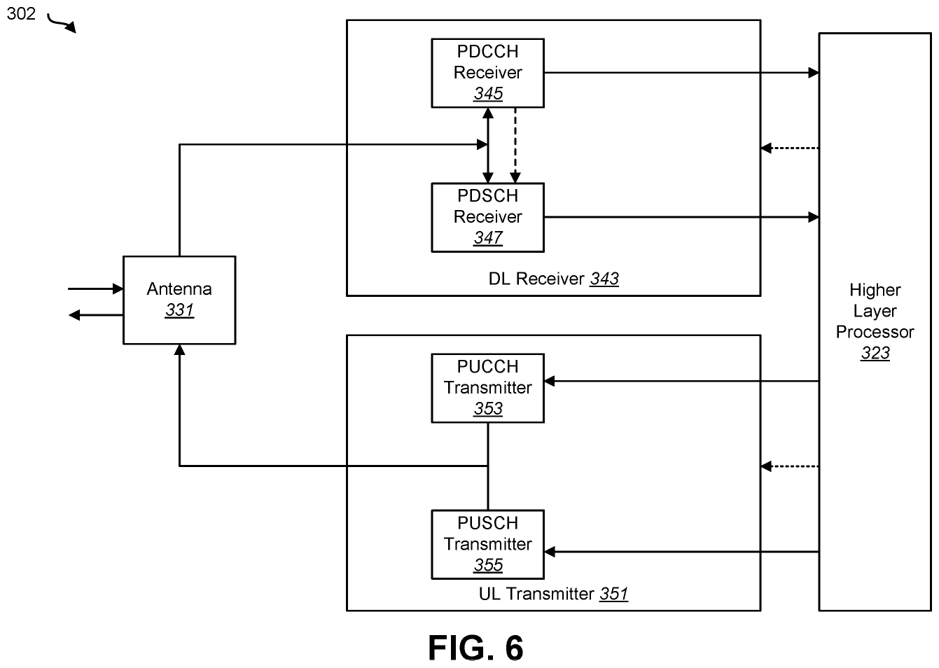

FIG. 6 is a block diagram illustrating one implementation of a UE 302. The UE 302 may be implemented in accordance with the UE 102 described in connection with FIG. 1 in some examples, and/or may perform one or more of the functions described herein. The UE 302 may include a higher layer processor 323, a UL transmitter 351, a DL receiver 343, and one or more antenna 331. The UL transmitter 351 may include a PUCCH transmitter 353 and a PUSCH transmitter 355. The DL receiver 343 may include a PDCCH receiver 345 and a PDSCH receiver 347.

The higher layer processor 323 may manage physical layer's behaviors (the UL transmitter's and the DL receiver's behaviors) and provide higher layer parameters to the physical layer. The higher layer processor 323 may obtain transport blocks from the physical layer. The higher layer processor 323 may send/acquire higher layer messages such as an RRC message and MAC message to/from a UE's higher layer. The higher layer processor 323 may provide the PUSCH transmitter transport blocks and provide the PUCCH transmitter 353 UCI.

The DL receiver 343 may receive multiplexed downlink physical channels and downlink physical signals via receiving antennas 331 and de-multiplex them. The PDCCH receiver 345 may provide the higher layer processor 323 DCI. The PDSCH receiver 347 may provide the higher layer processor 323 received transport blocks.

It should be noted that names of physical channels described herein are examples. The other names such as “NRPDCCH, NRPDSCH, NRPUCCH and NRPUSCH”, “new Generation-(G) PDCCH, GPDSCH, GPUCCH and GPUSCH” or the like can be used.

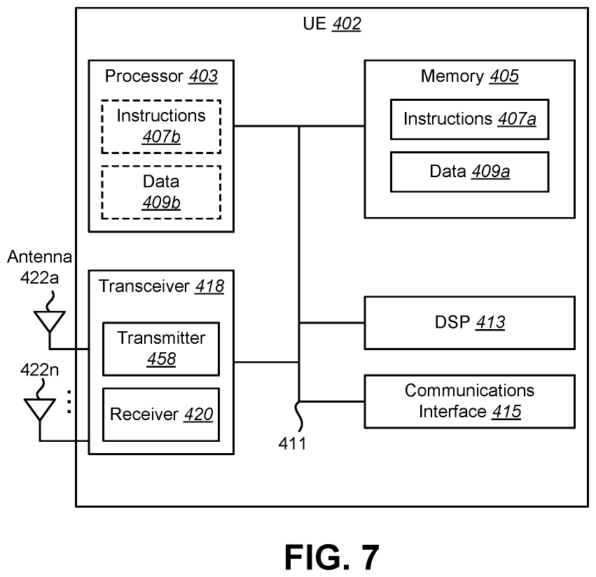

FIG. 7 illustrates various components that may be utilized in a UE 402. The UE 402 described in connection with FIG. 7 may be implemented in accordance with the UE 102 described in connection with FIG. 1. In some examples, the UE 402 may perform one or more of the methods, functions, operations, and/or examples, etc., described herein. The UE 402 includes a processor 403 that controls operation of the UE 402. The processor 403 may also be referred to as a central processing unit (CPU). Memory 405, which may include read-only memory (ROM), random access memory (RAM), a combination of the two or any type of device that may store information, provides instructions 407a and data 409a to the processor 403. A portion of the memory 405 may also include non-volatile random-access memory (NVRAM). Instructions 407b and data 409b may also reside in the processor 403. Instructions 407b and/or data 409b loaded into the processor 403 may also include instructions 407a and/or data 409a from memory 405 that were loaded for execution or processing by the processor 403. The instructions 407b may be executed by the processor 403 to implement the methods described above.

The UE 402 may also include a housing that contains one or more transmitters 458 and one or more receivers 420 to allow transmission and reception of data. The transmitter(s) 458 and receiver(s) 420 may be combined into one or more transceivers 418. One or more antennas 422a-n are attached to the housing and electrically coupled to the transceiver 418.

The various components of the UE 402 are coupled together by a bus system 411, which may include a power bus, a control signal bus, and a status signal bus, in addition to a data bus. However, for the sake of clarity, the various buses are illustrated in FIG. 7 as the bus system 411. The UE 402 may also include a digital signal processor (DSP) 413 for use in processing signals. The UE 402 may also include a communications interface 415 that provides user access to the functions of the UE 402. The UE 402 illustrated in FIG. 7 is a functional block diagram rather than a listing of specific components.

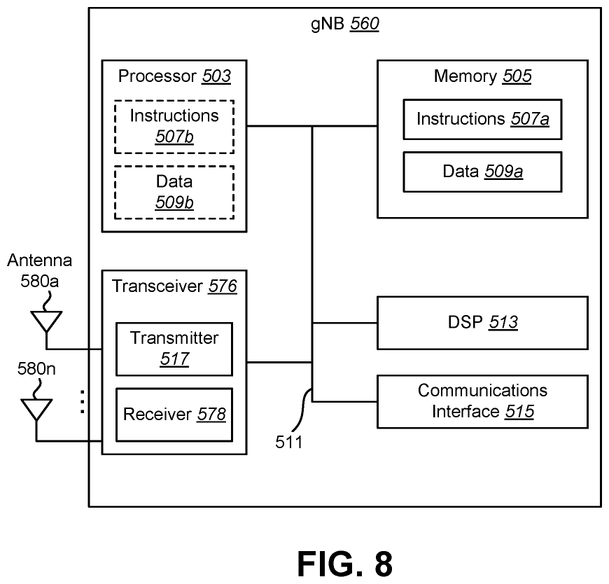

FIG. 8 illustrates various components that may be utilized in a gNB 560. The gNB 560 described in connection with FIG. 8 may be implemented in accordance with the gNB 160 described in connection with FIG. 1. In some examples, the gNB 560 may perform one or more of the methods, functions, operations, and/or examples, etc., described herein. The gNB 560 includes a processor 503 that controls operation of the gNB 560. The processor 503 may also be referred to as a central processing unit (CPU). Memory 505, which may include read-only memory (ROM), random access memory (RAM), a combination of the two or any type of device that may store information, provides instructions 507a and data 509a to the processor 503. A portion of the memory 505 may also include non-volatile random-access memory (NVRAM). Instructions 507b and data 509b may also reside in the processor 503. Instructions 507b and/or data 509b loaded into the processor 503 may also include instructions 507a and/or data 509a from memory 505 that were loaded for execution or processing by the processor 503. The instructions 507b may be executed by the processor 503 to implement the methods described above.

The gNB 560 may also include a housing that contains one or more transmitters 517 and one or more receivers 578 to allow transmission and reception of data. The transmitter(s) 517 and receiver(s) 578 may be combined into one or more transceivers 576. One or more antennas 580a-n are attached to the housing and electrically coupled to the transceiver 576.

The various components of the gNB 560 are coupled together by a bus system 511, which may include a power bus, a control signal bus, and a status signal bus, in addition to a data bus. However, for the sake of clarity, the various buses are illustrated in FIG. 8 as the bus system 511. The gNB 560 may also include a digital signal processor (DSP) 513 for use in processing signals. The gNB 560 may also include a communications interface 515 that provides user access to the functions of the gNB 560. The gNB 560 illustrated in FIG. 8 is a functional block diagram rather than a listing of specific components.

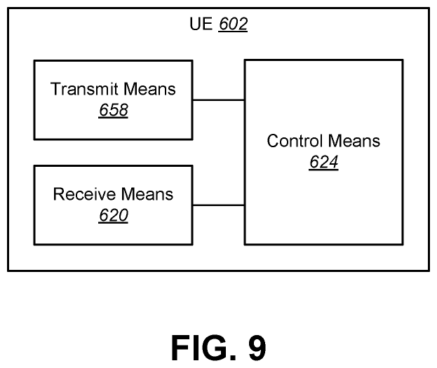

FIG. 9 is a block diagram illustrating one implementation of a UE 602 in which the systems and methods described herein may be implemented. The UE 602 includes transmit means 658, receive means 620 and control means 624. The transmit means 658, receive means 620 and control means 624 may be configured to perform one or more of the functions described in connection with FIG. 1 above. FIG. 7 above illustrates one example of a concrete apparatus structure of FIG. 9. Other various structures may be implemented to realize one or more of the functions of FIG. 1. For example, a DSP may be realized by software.

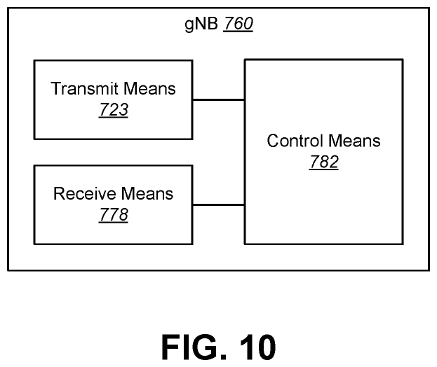

FIG. 10 is a block diagram illustrating one implementation of a gNB 760 in which the systems and methods described herein may be implemented. The gNB 760 includes transmit means 723, receive means 778 and control means 782. The transmit means 723, receive means 778 and control means 782 may be configured to perform one or more of the functions described in connection with FIG. 1 above. FIG. 8 above illustrates one example of a concrete apparatus structure of FIG. 10. Other various structures may be implemented to realize one or more of the functions of FIG. 1. For example, a DSP may be realized by software.

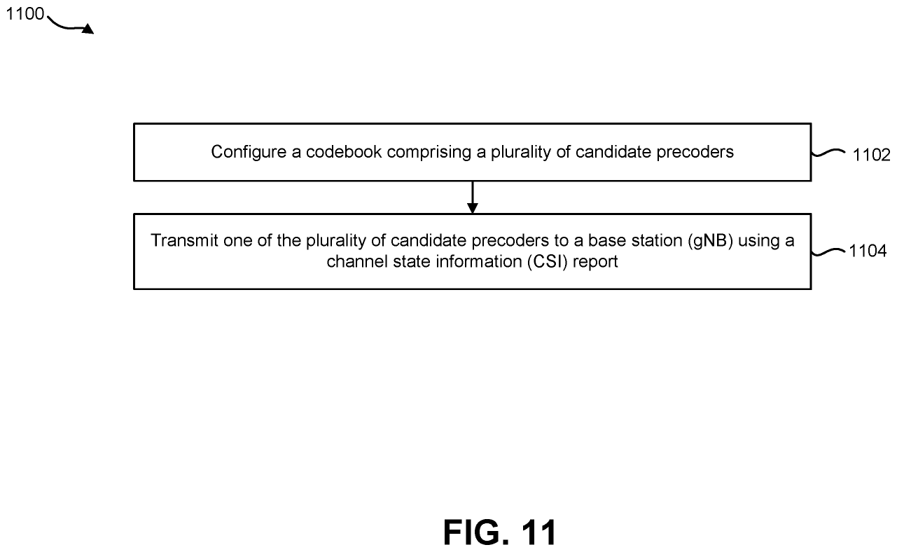

FIG. 11 is a flow diagram illustrating one example of a method 1100 that may be implemented by a UE. The UE may configure 1102 a codebook comprising a plurality of candidate precoders. The UE may then transmit 1104 one of the plurality of candidate precoders to a base station (gNB) using a channel state information (CSI) report.

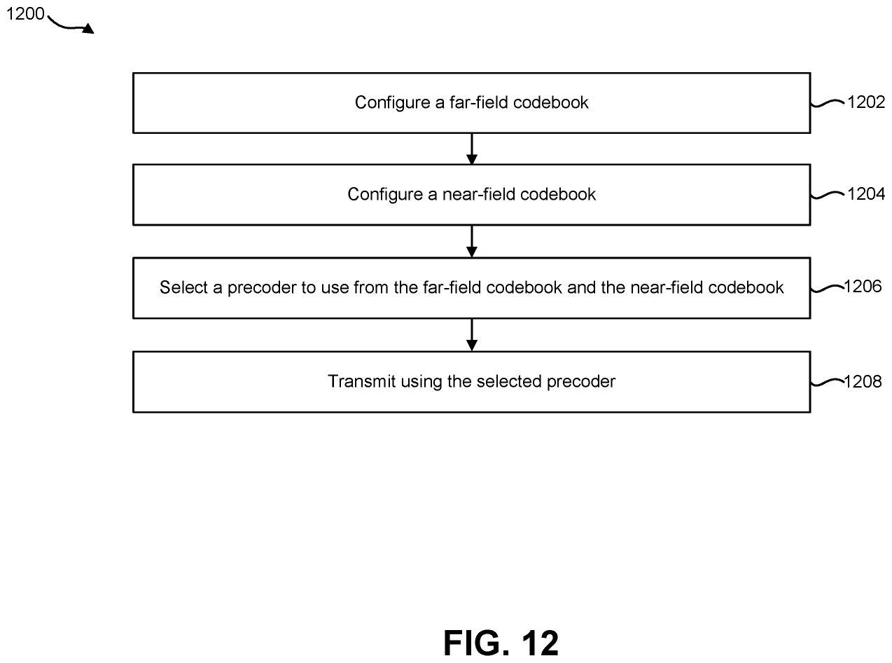

FIG. 12 is a flow diagram illustrating another example of a method 1200 that may be implemented by a UE. The UE may configure 1202 a far-field codebook. The UE may also configure 1204 a near-field codebook. The UE may select 1206 a precoder to use from the far-field codebook and the near-field codebook. The UE may transmit 1208 using the selected precoder.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. A user equipment (UE), comprising:
transmitting circuitry configured to:
configure a far-field codebook comprising a plurality of far-field candidate precoders;
configure a near-field codebook comprising a plurality of near-field candidate precoders;
select a codebook, and transmit using the selected codebook.

2. The UE of claim 1, wherein selecting the codebook to use comprises selecting a precoder to use, wherein the precoder is selected from the plurality of far-field candidate precoders and the plurality of near-field candidate precoders.

3. The UE of claim 1, further comprising:
receiving circuitry configured to:
receive a distance threshold from a base station (gNB) via radio resource control (RRC) signaling.

4. The UE of claim 1, further comprising:
receiving circuitry configured to:
if no distance threshold is received from the gNB, the UE can use the distance threshold as Rayleigh distance.

5. The UE of claim 1, further comprising:
receiving circuitry configured to:
receive a largest dimension of an antenna if it uses the Rayleigh distance from the gNB via radio resource control (RRC) signaling, wherein the Rayleigh distance is computed using the largest dimension of the antenna from the gNB and the wavelength.

6. The UE of claim 5, wherein the transmitting circuitry is further configured to transmit a request to the gNB for the largest dimension of the antenna.

7. The UE of claim 2, wherein selecting the codebook and the precoder to use within that codebook comprises comparing a distance (r) between the UE and a base station (gNB) with a distance threshold, wherein when r is greater than the distance threshold, a far-field precoder is selected, and wherein when r is less than the distance threshold, a near-field precoder is selected.

8. A base station (gNB), comprising:
receiving circuitry configured to:
configure a far-field codebook comprising a plurality of far-field candidate precoders;
configure a near-field codebook comprising a plurality of near-field candidate precoders;
receive a codebook selection from a user equipment (UE), wherein the codebook selection is selected from the far-field codebook and the near-field codebook; and
receive transmissions from the UE using the selected codebook.

9. The gNB of claim 8, wherein the codebook selection from the UE comprises a precoder selection, and wherein the precoder selection is selected from the plurality of far-field candidate precoders and the plurality of near-field candidate precoders.

10. The gNB of claim 8, further comprising:
transmitting circuitry configured to:
transmit a distance threshold to the UE via radio resource control (RRC) signaling.

11. The gNB of claim 8, further comprising:
transmitting circuitry configured to:
transmit a largest dimension of an antenna to the UE via radio resource control (RRC) signaling; and
wherein a distance threshold can be the Rayleigh distance, and wherein the Rayleigh distance is computed using the largest dimension of the antenna and the wavelength.

12. The gNB of claim 10, wherein the receiving circuitry is further configured to receive a request from the UE for the largest dimension of the antenna.

13. The gNB of claim 9, wherein the precoder selection is determined by comparing a distance (r) between the UE and the gNB with a distance threshold, wherein when r is greater than the distance threshold, a far-field precoder is selected, and wherein when r is less than the distance threshold, a near-field precoder is selected.
